(19) United States
(12) Patent Application Publication
(10) Pub. No.: US 2026/0061543 A1
(43) Pub. Date: Mar. 5, 2026

(54) ADDITIVE TOOLING

(71) Applicant: KENNAMETAL INC., LATROBE, PA (US)

(72) Inventor: Tyler Grimm, Latrobe, PA (US)

(73) Assignee: KENNAMETAL INC., LATROBE, PA (US)

(21) Appl. No.: 18/822,535

(22) Filed: Sep. 3, 2024

(51) Int. Cl. B24B 19/22; B29C 64/30; B29L 31/00; B33Y 10/00; B33Y 40/20; B33Y 80/00

(52) U.S. Cl. CPC B24B 19/22; B29C 64/30; B33Y 10/00; B33Y 40/20; B33Y 80/00; B29L 2031/72

(57) ABSTRACT

A method of manufacturing a cutting tool is disclosed. The cutting tool may be additively printed. This may allow the formation of a complex design with varying surfaces of the cutting tool in differing configurations and orientations. Then, a rake face and a flank face of the cutting tool may be grinded to form a cutting surface.

### FIELD OF THE DISCLOSURE

The disclosure generally relates to methods of manufacturing cutting tools using additive printing and grinding.

### BACKGROUND

Cutting tools are often manufactured using grinding. This may limit the complexity of the design of the cutting tool, due to the difficulty and cost of grinding complex designs, and may waste material.

An improved method of manufacturing cutting tools is needed to reduce one or more issues associated with the current methods their manufacture.

### SUMMARY

In one embodiment, a method of manufacturing a cutting tool is disclosed. In one step, the cutting tool may be additively printed. Then, a rake face and a flank face of the cutting tool may be grinded.

In another embodiment, a method of manufacturing a cutting tool is disclosed. In one step, the cutting tool may be additively printed to include a rake face, a flank face, a chip breaker, a cutting edge, a coolant hole or slot, and a coolant channel. Then, the rake face and the flank face of the cutting tool may be grinded.

In still another embodiment, a method of manufacturing a cutting tool is disclosed. In one step, the entire cutting tool may be additively printed to include a rake face, a flank face, a chip breaker, a cutting edge, a coolant hole or slot, and a coolant channel. Then, only the rake face and the flank face of the cutting tool may be grinded.

The scope of the present disclosure is defined solely by the appended claims and is not affected by the statements within this summary.

### BRIEF DESCRIPTION OF THE DRAWINGS

The disclosure can be better understood with reference to the following drawings and description. The components in the figures are not necessarily to scale, emphasis instead being placed upon illustrating the principles of the disclosure.

FIG. 1 is a flowchart illustrating one embodiment of a method of manufacturing a cutting tool;

FIG. 2 illustrates a side view of one embodiment of a cutting tool that may be manufactured using the method of FIG. 1;

FIG. 3 illustrates a close-up side view of a portion of one embodiment of a cutting tool that may be manufactured using the method of FIG. 1;

FIG. 4 illustrates a side view of a portion of one embodiment of a cutting tool that may be manufactured using the method of FIG. 1;

FIG. 5 illustrates a side view of a portion of one embodiment of a cutting tool that may be manufactured using the method of FIG. 1;

FIG. 6 illustrates a bottom perspective view of a portion of one embodiment of a cutting tool that may be manufactured using the method of FIG. 1;

FIG. 7 illustrates another bottom perspective view of the portion of the embodiment of the cutting tool of FIG. 6 that may be manufactured using the method of FIG. 1;

FIG. 8 illustrates a side view of a top portion of one embodiment of a cutting tool that may be manufactured using the method of FIG. 1;

FIG. 9 illustrates another side view of the top portion of the embodiment of the cutting tool of FIG. 8 that may be manufactured using the method of FIG. 1;

FIG. 10 illustrates still another side view of the top portion of the embodiment of the cutting tool of FIG. 8 that may be manufactured using the method of FIG. 1;

FIG. 11 illustrates a side view of a portion of one embodiment of a cutting tool that may be manufactured using the method of FIG. 1;

FIG. 12 illustrates a close-up side view of the portion of the embodiment of the cutting tool of FIG. 11 that may be manufactured using the method of FIG. 1;

FIG. 13 illustrates a side perspective view of one embodiment of a cutting tool that may be manufactured using the method of FIG. 1;

FIG. 14 illustrates a top perspective view of the embodiment of the cutting tool of FIG. 13 that may be manufactured using the method of FIG. 1;

FIG. 15 illustrates a side perspective view of a drill of one embodiment of a cutting tool that may be manufactured using the method of FIG. 1;

FIG. 16 illustrates a side perspective view of a drill of one embodiment of a cutting tool that may be manufactured using the method of FIG. 1;

FIG. 17 illustrates a top perspective view of a drill of one embodiment of a cutting tool that may be manufactured using the method of FIG. 1; and

FIG. 18 illustrates a top perspective view of one embodiment of a part that may be manufactured using the method of FIG. 1.

### DETAILED DESCRIPTION

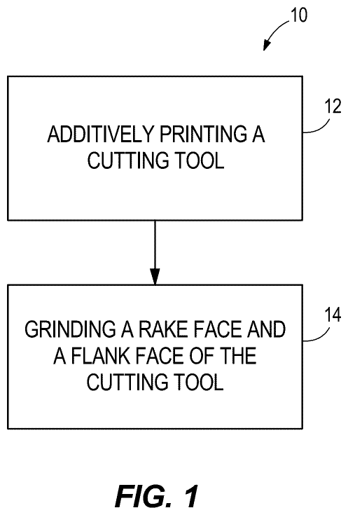

FIG. 1 is a flowchart illustrating one embodiment of a method 10 of manufacturing a cutting tool. In another embodiment, the method 10 may be used to manufacture another type of part or device other than a cutting tool. In step 12, the cutting tool may be additively printed. The additive printing may form one or more surfaces of the cutting tool having one or more embossed features. In one embodiment, the entire cutting tool may be additively printed including all surfaces of the cutting tool. The additively printed cutting tool may comprise an end mill, a drill, a tap, a turning tool, or a cutting insert. In other embodiments, the additively printed cutting tool may vary in type. Additively printing the cutting tool may be advantageous as it may be used to form varying complex surfaces and features of the cutting tool in differing shapes, patterns, orientations, alignments, configurations, sizes, and textures without sacrificing strength of the cutting tool. The cutting tool may be additively printed in near-net-shape to minimize the amount of material used in manufacturing the cutting tool. This may reduce the cost of manufacturing the cutting tool. The use of additive printing may allow much more complexity of the cutting tool design than grinding the cutting tool would allow. One or more surfaces of the cutting tool may be additively printed at any angle and orientation to achieve a precise cut or direct chip flow or coolant flow in a pre-determined direction to assist during a cutting process. The additive printing may optimize performance of the cutting tool without the limitation of requiring all surfaces of the cutting tool to be grinded. The additively printing may be used to form one or more portions of the cutting tool which may be difficult to manufacture without using additive printing.

In one embodiment, step 12 may further comprise additive printing a rake face of the cutting tool. In one embodiment, step 12 may further comprise additive printing a flank face of the cutting tool. In one embodiment, step 12 may further comprise additive printing a cutting edge of the cutting tool. In one embodiment, step 12 may further comprise additive printing a logo of the cutting tool. The logo may comprise an embossed feature used for marketing purposes. The logo may comprise a company name, a trademark, or another type of logo. In one embodiment, step 12 may further comprise additive printing a tool identifier of the cutting tool. The tool identifier may comprise a model number, a make, or an identifier number such as a serial number. In another embodiment, the tool identifier may vary. In one embodiment, step 12 may further comprise additive printing a chip breaker of the cutting tool. The printed chip breaker may optimize chip flow without sacrificing strength of the cutting tool. In one embodiment, step 12 may further comprise additive printing a flute of the cutting tool. The additively printed flute may include one or more inset features. In one embodiment, step 12 may further comprise additive printing a coolant slot of the cutting tool. The coolant slot may allow coolant to reach underneath a chip cut by the cutting tool to reduce chip-tool friction. In one embodiment, step 12 may further comprise additive printing a coolant hole of the cutting tool. In one embodiment, step 12 may further comprise additive printing a coolant channel of the cutting tool. In one embodiment, step 12 may further comprise additive printing the cutting tool to have at least one textured surface. In one embodiment, the at least one textured surface may comprise a bump or striation. In another embodiment, the at least one textured surface may vary. In one embodiment, step 12 may further comprise additive printing a recessed portion of the cutting tool. In other embodiments, step 12 may further comprise additive printing varying types of surfaces of the cutting tool in varying shapes, patterns, orientations, alignments, configurations, or sizes.

In step 14, a rake face and a flank face of the cutting tool may be grinded. The grinding of the rake face and the flank face may smooth the rake face and the flank face to form a cutting edge of the cutting tool. In one embodiment, only the rake face and the flank face of the cutting tool may be grinded. The printed rake face and flank face, prior to grinding, may be too rough and inaccurate to form an acceptable cutting edge. However, grinding the printed rake face and flank face may allow the formation of a sharp, accurate cutting edge minimizing the loss of material. In other embodiments, step 14 may further comprise grinding varying types of surfaces of the cutting tool.

In other embodiments, one or more steps of the method 10 of manufacturing the cutting tool may not be followed, one or more steps of the method 10 may be modified in substance or in order, or one or more additional steps may be added.

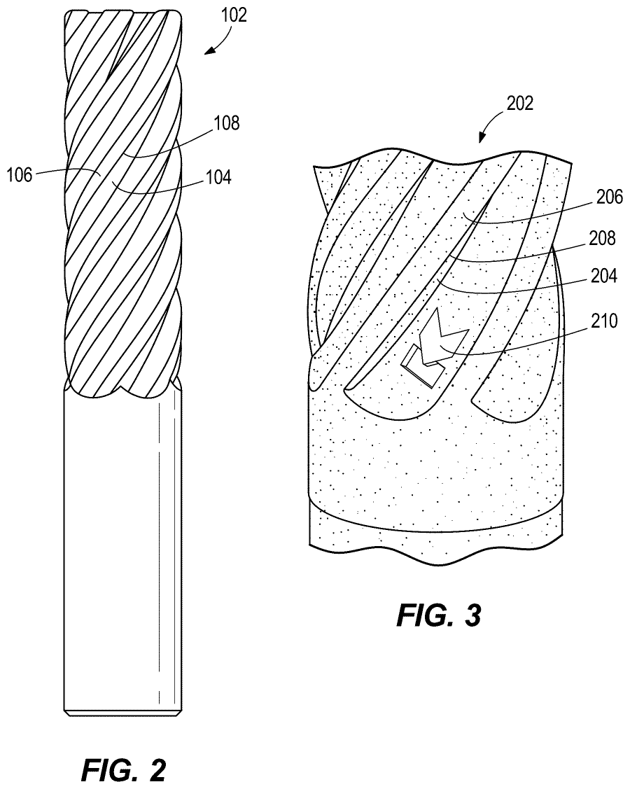

FIG. 2 illustrates a side view of one embodiment of a cutting tool 102 that may be manufactured using the method 10 of FIG. 1. The cutting tool 102 may comprise an end mill. In other embodiments, the cutting tool 102 may comprise varying types of cutting tools such as a drill, a tap, a turning tool, or a cutting insert. In still other embodiments, the cutting tool 102 may vary. The entire cutting tool 102, including in part a rake face 104 and a flank face 106, may have been additively printed to form the cutting tool 102 at near-net-shape. The remainder of the additively printed cutting tool 102 may comprise differing additively printed surfaces in varying configurations and orientations. The rake face 104 and the flank face 106 may then have been grinded to form a cutting edge 108. Only the rake face 104 and the flank face 106 may have been grinded. Minimal material may have been grinded from the rake face 104 and the flank face 106 to form the cutting edge 108 thereby minimizing the material loss. The cutting edge 108 may be accurate and precise due to the grinding method. The grinded rake face 104 and flank face 106 may be smooth. Other non-grinded portions of the cutting tool 102 may be rough. In other embodiments, varying portions of the cutting tool 102 may have been additively printed and/or grinded to form the desired cutting tool 102.

FIG. 3 illustrates a close-up side view of a portion of one embodiment of a cutting tool 202 that may be manufactured using the method 10 of FIG. 1. The cutting tool 202 may comprise an end mill. In other embodiments, the cutting tool 202 may comprise varying types of cutting tools such as a drill, a tap, a turning tool, or a cutting insert. In still other embodiments, the cutting tool 202 may vary. The entire cutting tool 202, including in part a rake face 204, a flank face 206, and a logo 210, may have been additively printed to form the cutting tool 202 at near-net-shape. The logo 210 may comprise an embossed feature used for marketing purposes. The logo 210 may comprise a company name, a trademark, or another type of logo. The remainder of the additively printed cutting tool 202 may comprise differing additively printed surfaces in varying configurations and orientations. The rake face 204 and the flank face 206 may then have been grinded to form a cutting edge 208. Only the rake face 204 and the flank face 206 may have been grinded. Minimal material may have been grinded from the rake face 204 and the flank face 206 to form the cutting edge 208 thereby minimizing the material loss. The cutting edge 208 may be accurate and precise due to the grinding method. The grinded rake face 204 and flank face 206 may be smooth. Other non-grinded portions of the cutting tool 202 may be rough. In other embodiments, varying portions of the cutting tool 202 may have been additively printed and/or grinded to form the desired cutting tool 202.

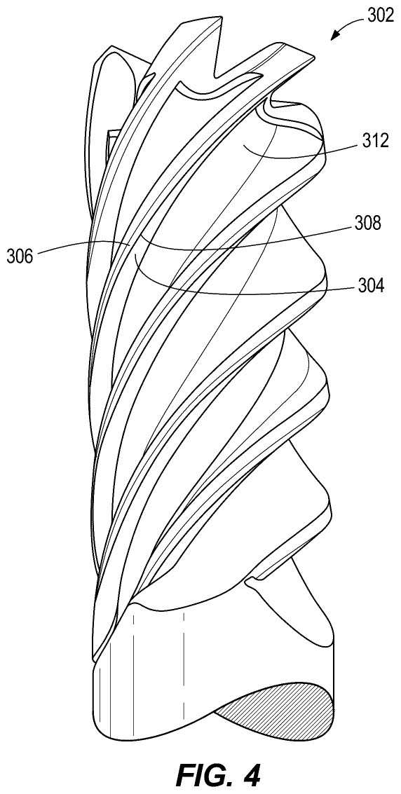

FIG. 4 illustrates side view of a portion of one embodiment of a cutting tool 302 that may be manufactured using the method 10 of FIG. 1. The cutting tool 302 may comprise an end mill. In other embodiments, the cutting tool 302 may comprise varying types of cutting tools such as a drill, a tap, a turning tool, or a cutting insert. In still other embodiments, the cutting tool 302 may vary. The entire cutting tool 302, including in part a rake face 304, a flank face 306, and a chip breaker 312, may have been additively printed to form the cutting tool 302 at near-net-shape. The chip breaker 312 may optimize chip flow without sacrificing strength of the cutting tool 302. The remainder of the additively printed cutting tool 302 may comprise differing additively printed surfaces in varying configurations and orientations. The rake face 304 and the flank face 306 may then have been grinded to form a cutting edge 308. Only the rake face 304 and the flank face 306 may have been grinded. Minimal material may have been grinded from the rake face 304 and the flank face 306 to form the cutting edge 308 thereby minimizing the material loss. The cutting edge 308 may be accurate and precise due to the grinding method. The grinded rake face 304 and flank face 306 may be smooth. Other non-grinded portions of the cutting tool 302 may be rough. In other embodiments, varying portions of the cutting tool 302 may have been additively printed and/or grinded to form the desired cutting tool 302.

FIG. 5 illustrates side view of a portion of one embodiment of a cutting tool 402 that may be manufactured using the method 10 of FIG. 1. The cutting tool 402 may comprise an end mill such as a Harvi I TE model. In other embodiments, the cutting tool 402 may comprise varying types of cutting tools such as a drill, a tap, a turning tool, or a cutting insert. In still other embodiments, the cutting tool 402 may vary. The entire cutting tool 402, including in part a rake face 404, a flank face 406, a flute 413, and an insert feature 414, may have been additively printed to form the cutting tool 402 at near-net-shape. The insert feature 414 within the flute 413 may comprise chip breakers to break up chips cut by the cutting tool 402. In additional embodiments, small slots may be additively printed in or adjacent to the chip breakers to enabling coolant to reach underneath chips cut by the cutting tool 402 to reduce chip-tool friction. The remainder of the additively printed cutting tool 402 may comprise differing additively printed surfaces in varying configurations and orientations. The rake face 404 and the flank face 406 may then have been grinded to form a cutting edge 408. Only the rake face 404 and the flank face 406 may have been grinded. Minimal material may have been grinded from the rake face 404 and the flank face 406 to form the cutting edge 408 thereby minimizing the material loss. The cutting edge 408 may be accurate and precise due to the grinding method. The grinded rake face 404 and flank face 406 may be smooth. Other non-grinded portions of the cutting tool 402 may be rough. In other embodiments, varying portions of the cutting tool 402 may have been additively printed and/or grinded to form the desired cutting tool 402.

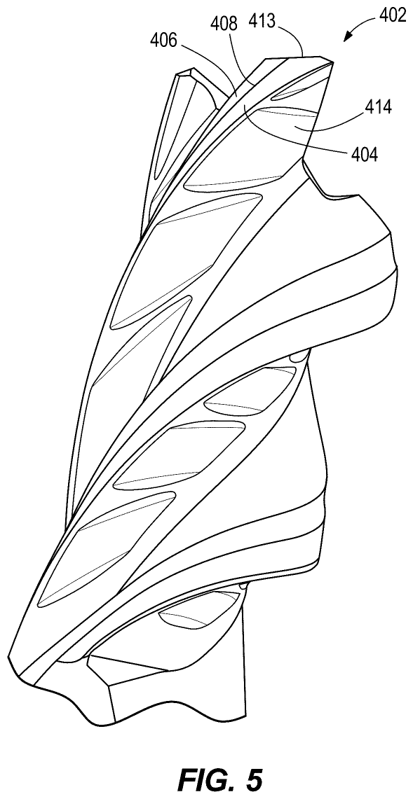

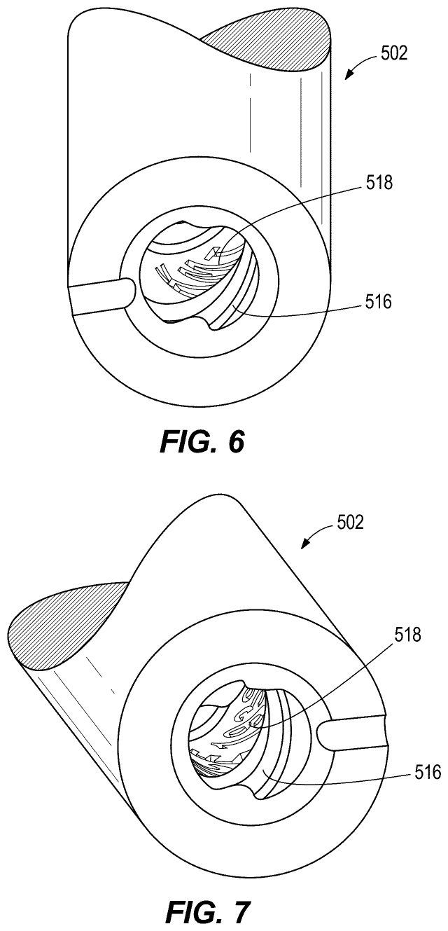

FIGS. 6-7 illustrate respectively differing bottom perspective views of a portion of one embodiment of a cutting tool 502 that may be manufactured using the method 10 of FIG. 1. The cutting tool 502 may comprise an end mill. In other embodiments, the cutting tool 502 may comprise varying types of cutting tools such as a drill, a tap, a turning tool, or a cutting insert. In still other embodiments, the cutting tool 502 may vary. The entire cutting tool 502, including in part a rake face (not shown), a flank face (not shown), a coolant channel 516, and a tool identifier 518 may have been additively printed to form the cutting tool 502. The additively printed cutting tool 502 may be textured with bumps, striations, or another textured surface. The tool identifier 518 may comprise a model number, a make, or an identifier number such as a serial number. In another embodiment, the tool identifier 518 may comprise another embossed feature used for marketing purposes. The remainder of the additively printed cutting tool 502 may comprise differing additively printed surfaces in varying configurations and orientations. The rake face (not shown) and the flank face (not shown) may then have been grinded to form a cutting edge (not shown). Only the rake face (not shown) and the flank face (not shown) may have been grinded. Minimal material may have been grinded from the rake face (not shown) and the flank face (not shown) to form the cutting edge (not shown) hereby minimizing the material loss. The cutting edge (not shown) may be accurate and precise due to the grinding method. The grinded rake face (not shown) and flank face (not shown) may be smooth. Other non-grinded portions of the cutting tool 502 may be rough. In other embodiments, varying portions of the cutting tool 502 may have been additively printed and/or grinded to form the desired cutting tool 502.

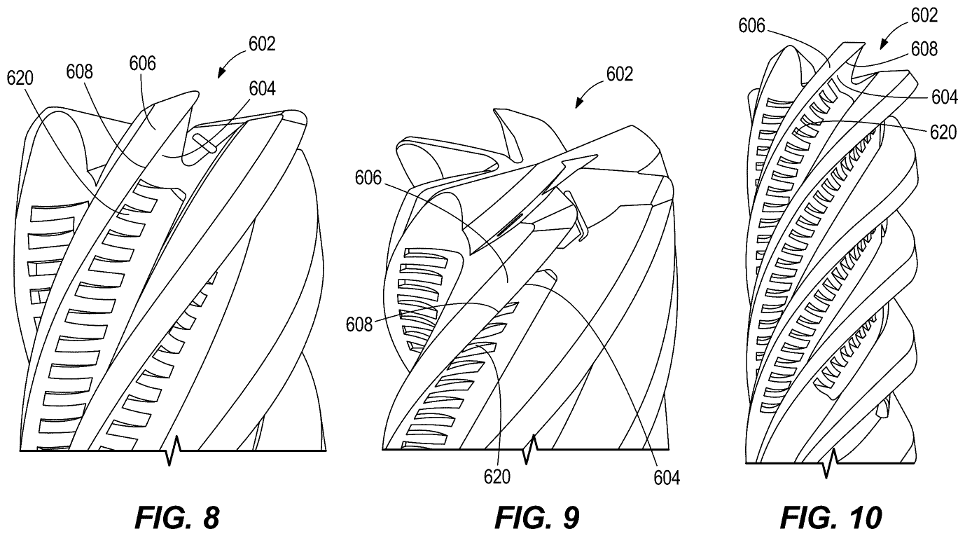

FIGS. 8-10 illustrate respectively differing side views of a top portion of one embodiment of a cutting tool 602 that may be manufactured using the method 10 of FIG. 1. The cutting tool 602 may comprise an end mill. In other embodiments, the cutting tool 602 may comprise varying types of cutting tools such as a drill, a tap, a turning tool, or a cutting insert. In still other embodiments, the cutting tool 602 may vary. The entire cutting tool 602, including in part a rake face 604, a flank face 606, and a chip breaker 620 may have been additively printed to form the cutting tool 602. The chip breaker 620 may be recessed and comprise surfaces along the rake face 604 which are discontinuous and negatively sloped from a cutting edge 608. The chip breaker 620 may be created to optimize chip flow without sacrificing strength. The geometry of the chip breaker 620 may be optimized for performance without the limitation of needing to be grindable. The remainder of the additively printed cutting tool 602 may comprise differing additively printed surfaces in varying configurations and orientations. The rake face 604 and the flank face 606 may then have been grinded to form the cutting edge 608. Only the rake face 604 and the flank face 606 may have been grinded. Minimal material may have been grinded from the rake face 604 and the flank face 606 to form the cutting edge 608 thereby minimizing the material loss. The cutting edge 608 may be accurate and precise due to the grinding method. The grinded rake face 604 and flank face 606 may be smooth. Other non-grinded portions of the cutting tool 602 may be rough. In other embodiments, varying portions of the cutting tool 602 may have been additively printed and/or grinded to form the desired cutting tool 602.

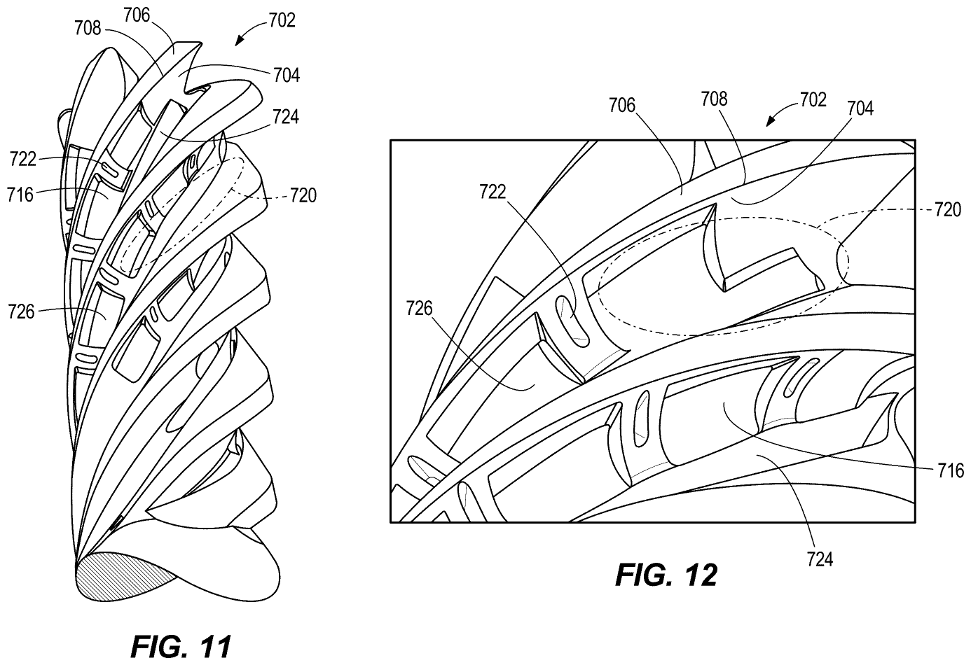

FIGS. 11-12 illustrate respectively a side view and a close-up side view of a portion of one embodiment of a cutting tool 702 that may be manufactured using the method 10 of FIG. 1. The cutting tool 702 may comprise an end mill. In other embodiments, the cutting tool 702 may comprise varying types of cutting tools such as a drill, a tap, a turning tool, or a cutting insert. In still other embodiments, the cutting tool 702 may vary. The entire cutting tool 702, including in part a rake face 704, a flank face 706, a coolant channel 716, a chip breaker 720, a coolant hole 722, a coolant slot 724, and a recessed portion 726 may have been additively printed to form the cutting tool 702. The remainder of the additively printed cutting tool 702 may comprise differing additively printed surfaces in varying configurations and orientations. The rake face 704 and the flank face 706 may then have been grinded to form a cutting edge 708. Only the rake face 704 and the flank face 706 may have been grinded. Minimal material may have been grinded from the rake face 704 and the flank face 706 to form the cutting edge 708 thereby minimizing the material loss. The cutting edge 708 may be accurate and precise due to the grinding method. The grinded rake face 704 and flank face 706 may be smooth. Other non-grinded portions of the cutting tool 702 may be rough. In other embodiments, varying portions of the cutting tool 702 may have been additively printed and/or grinded to form the desired cutting tool 702.

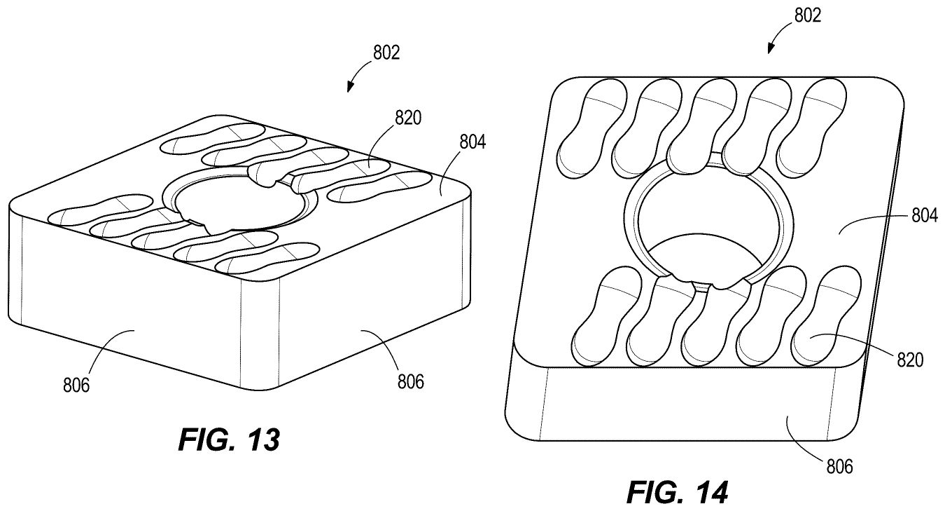

FIGS. 13-14 illustrate respectively differing side and top perspective views of one embodiment of a cutting tool 802 that may be manufactured using the method 10 of FIG. 1. The cutting tool 802 may comprise a cutting insert. In other embodiments, the cutting tool 802 may comprise varying types of cutting tools such as an end drill, a drill, a tap, or a turning tool. In still other embodiments, the cutting tool 802 may vary. The entire cutting tool 802, including in part a rake face 804, a flank face 806, and a chip breaker 820 may have been additively printed to form the cutting tool 802. The chip breaker 820 may be recessed and oriented to direct chip flow cut by the cutting tool 802 in a certain direction. The chip breaker 820 may have closed angles which would be difficult to manufacture without using additive printing. The chip breaker 820 may be created to optimize chip flow without sacrificing strength. The geometry of the chip breaker 820 may be optimized for performance without the limitation of needing to be grindable. The remainder of the additively printed cutting tool 802 may comprise differing additively printed surfaces in varying configurations and orientations. The rake face 804 and the flank face 806 may then have been grinded to form a cutting edge 808. Only the rake face 804 and the flank face 806 may have been grinded. Minimal material may have been grinded from the rake face 804 and the flank face 806 to form the cutting edge 808 thereby minimizing the material loss. The cutting edge 808 may be accurate and precise due to the grinding method. The grinded rake face 804 and flank face 806 may be smooth. Other non-grinded portions of the cutting tool 802 may be rough. In other embodiments, varying portions of the cutting tool 802 may have been additively printed and/or grinded to form the desired cutting tool 802.

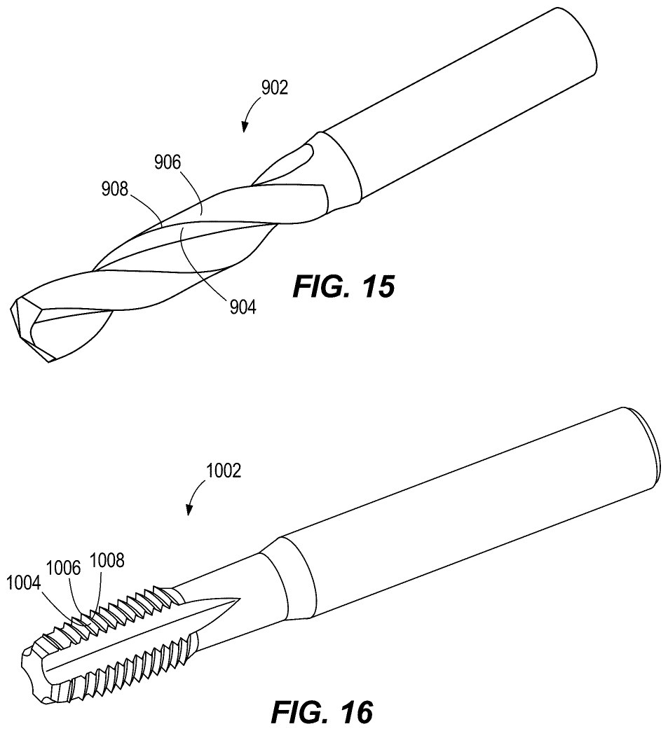

FIG. 15 illustrates a side perspective view of a drill of one embodiment of a cutting tool 902 that may be manufactured using the method 10 of FIG. 1. The cutting tool 902 may comprise a drill. In other embodiments, the cutting tool 902 may comprise varying types of cutting tools such as an end drill, a tap, a turning tool, or a cutting insert. In still other embodiments, the cutting tool 902 may vary. The entire cutting tool 902, including in part a rake face 904, and a flank face 906 may have been additively printed to form the cutting tool 902. The remainder of the additively printed cutting tool 902 may comprise differing additively printed surfaces in varying configurations and orientations. The rake face 904 and the flank face 906 may then have been grinded to form a cutting edge 908. Only the rake face 904 and the flank face 906 may have been grinded. Minimal material may have been grinded from the rake face 904 and the flank face 906 to form the cutting edge 908 thereby minimizing the material loss. The cutting edge 908 may be accurate and precise due to the grinding method. The grinded rake face 904 and flank face 906 may be smooth. Other non-grinded portions of the cutting tool 902 may be rough. In other embodiments, varying portions of the cutting tool 902 may have been additively printed and/or grinded to form the desired cutting tool 902.

FIG. 16 illustrates a side perspective view of a drill of one embodiment of a cutting tool 1002 that may be manufactured using the method 10 of FIG. 1. The cutting tool 1002 may comprise a tap. In other embodiments, the cutting tool 1002 may comprise varying types of cutting tools such as an end drill, a drill, a turning tool, or a cutting insert. In still other embodiments, the cutting tool 1002 may vary. The entire cutting tool 1002, including in part a rake face 1004, and a flank face 1006 may have been additively printed to form the cutting tool 1002. The remainder of the additively printed cutting tool 1002 may comprise differing additively printed surfaces in varying configurations and orientations. The rake face 1004 and the flank face 1006 may then have been grinded to form a cutting edge 1008. Only the rake face 1004 and the flank face 1006 may have been grinded. Minimal material may have been grinded from the rake face 1004 and the flank face 1006 to form the cutting edge 1008 thereby minimizing the material loss. The cutting edge 1008 may be accurate and precise due to the grinding method. The grinded rake face 1004 and flank face 1006 may be smooth. Other non-grinded portions of the cutting tool 1002 may be rough. In other embodiments, varying portions of the cutting tool 1002 may have been additively printed and/or grinded to form the desired cutting tool 1002.

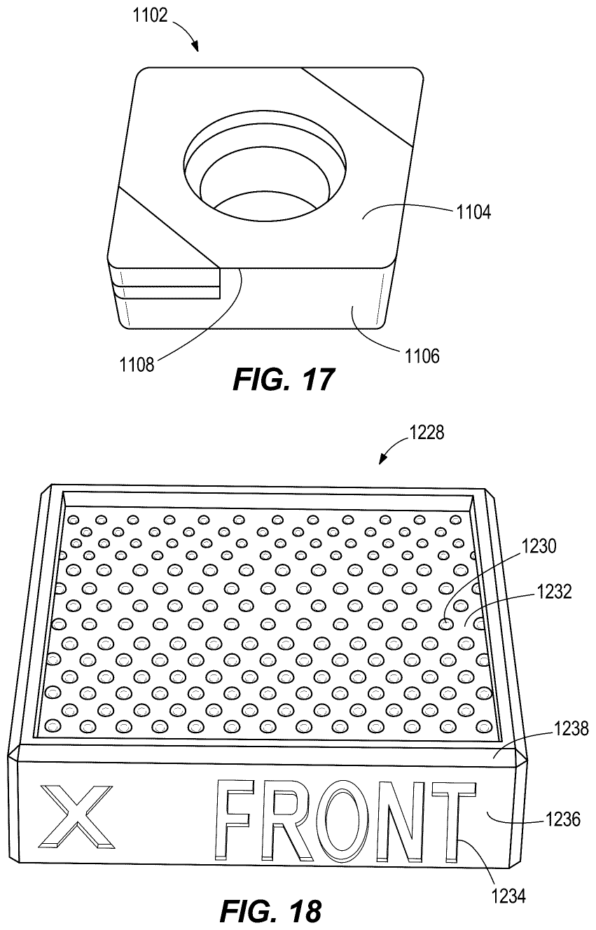

FIG. 17 illustrates a top perspective view of one embodiment of a cutting tool 1102 that may be manufactured using the method 10 of FIG. 1. The cutting tool 1102 may comprise a turning tool such as a turning insert. In other embodiments, the cutting tool 1102 may comprise varying types of turning tools. In other embodiments, the cutting tool 1102 may comprise varying types of cutting tools such as an end drill, a drill, a tap, or a cutting insert. In still other embodiments, the cutting tool 1102 may vary. The entire cutting tool 1102, including in part a rake face 1104, and a flank face 1106 may have been additively printed to form the cutting tool 1102. The remainder of the additively printed cutting tool 1102 may comprise differing additively printed surfaces in varying configurations and orientations. The rake face 1104 and the flank face 1106 may then have been grinded to form a cutting edge 1108. Only the rake face 1104 and the flank face 1106 may have been grinded. Minimal material may have been grinded from the rake face 1104 and the flank face 1106 to form the cutting edge 1108 thereby minimizing the material loss. The cutting edge 1108 may be accurate and precise due to the grinding method. The grinded rake face 1104 and flank face 1106 may be smooth. Other non-grinded portions of the cutting tool 1102 may be rough. In other embodiments, varying portions of the cutting tool 1102 may have been additively printed and/or grinded to form the desired cutting tool 1102.

FIG. 18 illustrates a top perspective view of one embodiment of a part 1228 that may be manufactured using the method 10 of FIG. 1. The part 1228 may comprise a cutting tool, another type of tool, or a varying type of part. The entire part 1228 may have been additively printed to form in part bumps 1230 on surface 1232 and letters 1234 on surface 1236. The remainder of the additively printed part 1128 may comprise differing printed surfaces in varying orientations and configurations. Surface 1238 of the part 1228 may have been grinded to be smooth. Other non-grinded portions of the part 1228 may be rough. In other embodiments, varying portions of the part 1228 may have been additively printed and/or grinded to form the desired part 1228.

One or more embodiments of the disclosure may reduce one or more issues associated with the current methods of manufacturing cutting tools. For instance, additive printing an entire cutting tool at near-net-shape followed by grinding only a rake face and a flake face to form an accurate cutting edge may allow for a complex cutting tool to be manufactured at minimal cost.

The Abstract is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true scope of the subject matter described herein. Furthermore, it is to be understood that the disclosure is defined by the appended claims. Accordingly, the disclosure is not to be restricted except in light of the appended claims and their equivalents.

1. A method of manufacturing a cutting tool comprising:
additive printing the cutting tool; and then grinding a rake face and a flank face of the cutting tool.

2. The method of claim 1 wherein the additive printing the cutting tool comprises additive printing the entire cutting tool.

3. The method of claim 1 wherein the grinding comprises only grinding the rake face and the flank face of the cutting tool.

4. The method of claim 1 wherein the cutting tool comprises an end mill.

5. The method of claim 1 wherein the cutting tool comprises a drill.

6. The method of claim 1 wherein the cutting tool comprise a tap.

7. The method of claim 1 wherein the cutting tool comprises a turning tool.

8. The method of claim 1 wherein the cutting tool comprises a cutting insert.

9. The method of claim 1 wherein the additive printing the cutting tool further comprises additive printing a rake face of the cutting tool.

10. The method of claim 1 wherein the additive printing the cutting tool further comprises additive printing a flank face of the cutting tool.

11. The method of claim 1 wherein the additive printing the cutting tool further comprises additive printing a cutting edge of the cutting tool.

12. The method of claim 1 wherein the additive printing the cutting tool further comprises additive printing a logo of the cutting tool.

13. The method of claim 1 wherein the additive printing the cutting tool further comprises additive printing a tool identifier of the cutting tool.

14. The method of claim 1 wherein the additive printing the cutting tool further comprises additive printing a chip breaker of the cutting tool.

15. The method of claim 1 wherein the additive printing the cutting tool further comprises additive printing a flute of the cutting tool.

16. The method of claim 1 wherein the additive printing the cutting tool further comprises additive printing a coolant slot of the cutting tool.

17. The method of claim 1 wherein the additive printing the cutting tool further comprises additive printing a coolant hole of the cutting tool.

18. The method of claim 1 wherein the additive printing the cutting tool further comprises additive printing a coolant channel of the cutting tool.

19. The method of claim 1 wherein the additive printing the cutting tool further comprises additive printing the cutting tool to have at least one textured surface.

20. The method of claim 19 wherein the at least one textured surface comprises a bump or striation.

21. The method of claim 1 wherein the additive printing the cutting tool further comprises additive printing a recessed portion of the cutting tool.

22. A method of manufacturing a cutting tool comprising:
additive printing the cutting tool including a rake face, a flank face, a chip breaker, a cutting edge, a coolant hole or slot, and a coolant channel; and then
grinding the rake face and the flank face of the cutting tool.

23. The method of claim 22 wherein the cutting tool comprises an end mill, a drill, a tap, a turning tool, or a cutting insert.

24. A method of manufacturing a cutting tool comprising:
additive printing the entire cutting tool including a rake face, a flank face, a chip breaker, a cutting edge, a coolant hole or slot, and a coolant channel; and then
grinding only the rake face and the flank face of the cutting tool.
